(19) United States
(12) Patent Application Publication
(10) Pub. No.: US 2024/0393360 A1
(43) Pub. Date: Nov. 28, 2024

(54) INERTIAL SENSOR MODULE, INERTIAL MEASUREMENT UNIT, AND ELECTRONIC APPARATUS

(71) Applicant: SEIKO EPSON CORPORATION, Tokyo (JP)

(72) Inventor: Masayasu Sakuma, Shiojiri-shi (JP)

(21) Appl. No.: 18/673,586

(22) Filed: May 24, 2024

(30) Foreign Application Priority Data
May 26, 2023 (JP) 2023-086770

(51) Int. Cl. G01P 1/02

(52) U.S. Cl. CPC G01P 1/026

(57) ABSTRACT

An inertial sensor module includes a first inertial sensor that detects a physical quantity of a first axis, a second inertial sensor that detects the physical quantity of the first axis, a substrate includes a first region in which the first inertial sensor and the second inertial sensor are mounted, a second region surrounding the first region, and a plurality of slits provided between the first region and the second region to surround the first region.

The present application is based on, and claims priority from JP Application Serial Number 2023-086770, filed May 26, 2023, the disclosure of which is hereby incorporated by reference herein in its entirety.

### BACKGROUND

### 1. Technical Field

The present disclosure relates to an inertial sensor module, an inertial measurement unit including the inertial sensor module, and an electronic apparatus including the inertial sensor module.

### 2. Related Art

As an inertial sensor module that measures an acceleration, an angular velocity, or the like, for example, an inertial sensor module described in JP-A-2019-158425 is known.

JP-A-2019-158425 describes a circuit substrate on which a multi-axis inertial sensor that accommodates a three-axis angular velocity sensor and a three-axis acceleration sensor, a single-axis angular velocity sensor, and a connector are mounted.

Such an inertial sensor module is required to ensure a reliability of a detection accuracy when an external fluctuation such as a temperature change occurs.

### SUMMARY

According to an aspect of the present disclosure, there is provided an inertial sensor module including a first inertial sensor that detects a physical quantity of a first axis, a second inertial sensor that detects the physical quantity of the first axis, a substrate includes a first region in which the first inertial sensor and the second inertial sensor are mounted, a second region surrounding the first region, and a plurality of slits provided between the first region and the second region to surround the first region.

According to another aspect of the present disclosure, there is provided an inertial sensor module including a first inertial sensor that detects a physical quantity of a first axis; a second inertial sensor that detects the physical quantity of the first axis; and a substrate including a first region in which the first inertial sensor and the second inertial sensor are mounted, a second region surrounding the first region, a third region surrounding the first region between the first region and the second region, a first plurality of slits provided between the first region and the third region to surround the first region, and a second plurality of slits provided between the third region and the second region to surround the third region.

According to still another aspect of the present disclosure, there is provided an inertial measurement unit including the inertial sensor module.

According to still another aspect of the present disclosure, there is provided an electronic apparatus including the inertial sensor module.

### BRIEF DESCRIPTION OF THE DRAWINGS

FIG. 1 is a perspective view of an inertial sensor module according to Embodiment 1.

FIG. 2 is a plan view of the inertial sensor module according to Embodiment 1.

FIG. 3A is a cross-sectional view of the inertial sensor module taken along the line A-A of FIG. 1.

FIG. 3B is a cross-sectional view of the inertial sensor module taken along the line A-A in FIG. 1.

FIG. 4A is a plan view of an inertial sensor module according to Modification Example 1.

FIG. 4B is a plan view of an inertial sensor module according to Modification Example 2.

FIG. 4C is a plan view of an inertial sensor module according to Modification Example 3.

FIG. 4D is a plan view of an inertial sensor module according to Modification Example 4.

FIG. 4E is a plan view of an inertial sensor module according to Modification Example 5.

FIG. 4F is a plan view of an inertial sensor module according to Modification Example 6.

FIG. 5 is a block diagram of the inertial sensor module.

FIG. 6 is a perspective view of an inertial sensor module according to Embodiment 2.

FIG. 7 is a plan view of the inertial sensor module according to Embodiment 2.

FIG. 8A is a plan view of an inertial sensor module according to Modification Example 7.

FIG. 8B is a plan view of an inertial sensor module according to Modification Example 8.

FIG. 9 is a perspective view of an inertial measurement unit according to Embodiment 3.

FIG. 10 is a perspective view of the inertial measurement unit according to Embodiment 3.

FIG. 11 is an exploded perspective view of the inertial measurement unit according to Embodiment 3.

FIG. 12 is a perspective view of the inertial sensor module according to Embodiment 3.

FIG. 13 is a perspective view of an electronic apparatus according to Embodiment 4.

FIG. 14 is a perspective view of an electronic apparatus according to Embodiment 4.

### DESCRIPTION OF EMBODIMENTS

Hereinafter, embodiments of the present disclosure will be described with reference to the drawings.

In the following drawings, dimensions may be scaled differently depending on components in order to make the components easier to see.

In addition, in the following, for convenience of description, three axes orthogonal to each other are referred to as an X axis, a Y axis, and a Z axis. In addition, a direction parallel to the X axis is also referred to as an X-axis direction, a direction parallel to the Y axis is also referred to as a Y-axis direction, and a direction parallel to the Z axis is also referred to as a Z-axis direction. In addition, a tip end side in an arrow direction of each axis is also referred to as a positive side, and an opposite side is also referred to as a negative side. In addition, viewing in the Z-axis direction is also referred to as a plan view, and viewing from the Y-axis direction with respect to a cross section including the z axis is also referred to as a cross-sectional view.

Further, in the following description, for example, the description of “on the substrate” refers to any of a case of being disposed in contact with the substrate, a case of being disposed on the substrate via another structure, or a case of being partially disposed in contact with the substrate and being partially disposed on the substrate via another structure. In addition, for example, the description of the “upper surface of the substrate” is assumed to indicate a surface of the substrate on the positive side in the Z-axis direction. In addition, for example, the description of the “lower surface of the substrate” is assumed to indicate a surface of the substrate on the negative side in the Z-axis direction.

### 1. Embodiment 1

In the present embodiment, first, a basic configuration of an inertial sensor module 100 according to Embodiment 1 will be described, and then, an application configuration will be described.

### 1.1. Basic Configuration of Inertial Sensor Module

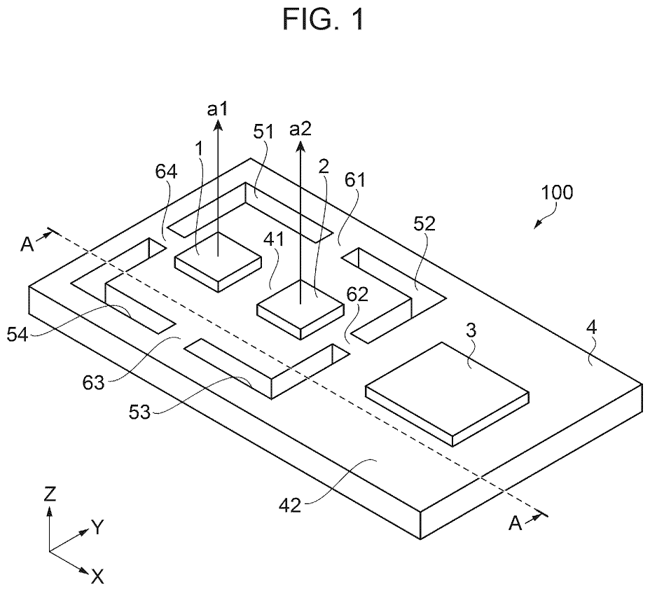

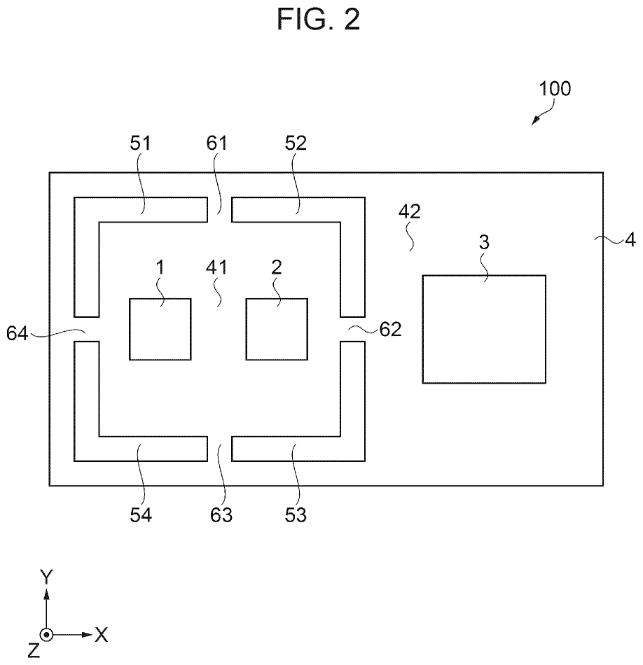

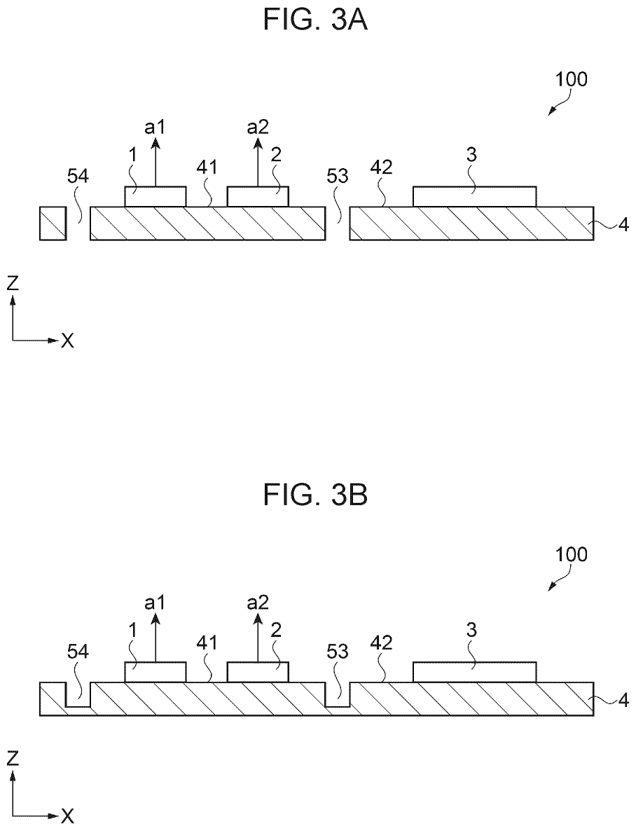

FIG. 1 is a perspective view of the inertial sensor module 100 according to Embodiment 1. FIG. 2 is a plan view of the inertial sensor module 100 according to Embodiment 1. FIGS. 3A and 3B are cross-sectional views taken along the line A-A of FIG. 1.

As illustrated in FIGS. 1 and 2, the inertial sensor module 100 includes a first inertial sensor 1, a second inertial sensor 2, a processing device 3, and a substrate 4. In the present embodiment, the first inertial sensor 1 is an example of a first inertial sensor, the second inertial sensor 2 is an example of a second inertial sensor, and the processing device 3 is an example of a processing device.

### 1.1.1. Regarding Substrate

The substrate 4 has a first region 41, a second region 42, slits 51, 52, 53, and 54, and support portions 61, 62, 63, and 64. In the present embodiment, the slits 51, 52, 53, and 54 are examples of a plurality of slits, the slit 51 is an example of a first slit, the slit 52 is an example of a second slit, the slit 53 is an example of a third slit, and the slit 54 is an example of a fourth slit. Further, the support portions 61, 62, 63, and 64 are examples of a plurality of support portions, the support portion 61 is an example of a first support portion, the support portion 62 is an example of a second support portion, the support portion 63 is an example of a third support portion, and the support portion 64 is an example of a fourth support portion.

The first region 41 is located inside the second region 42. In other words, the second region 42 surrounds the first region 41. A shape of the first region 41 is a rectangle. The shape of the first region 41 is not limited to a rectangle. The shape may be a polygon including a rhombus, a triangle, and a hexagon, a circle including an ellipse, and the like.

The first inertial sensor 1 and the second inertial sensor 2 are mounted in the first region 41. The processing device 3 is mounted in the second region 42.

The slits 51, 52, 53, and 54 are provided between the first region 41 and the second region 42. The slits 51, 52, 53, and 54 are provided along a periphery of the first region 41 to surround the first region 41. In other words, the first region 41 is surrounded on four sides by the slits 51, 52, 53, and 54.

Further, the slits 51, 52, 53, and 54 surround four sides of the first inertial sensor 1 and the second inertial sensor 2. The four sides can be read as four sides or a periphery of the first region 41, four sides or a periphery of the first inertial sensor 1, or four sides or a periphery of the second inertial sensor 2.

The slits 51, 52, 53, and 54 each have a shape having two sides of a right-angled isosceles triangle intersecting each other at a right angle. The shape of the slits 51, 52, 53, and 54 is not limited thereto. The other shapes of the slits 51, 52, 53, and 54 will be described in a modification example described later.

As illustrated in FIG. 3A, the slit 53 and the slit 54 are preferably holes penetrating the substrate 4. The slit 51 and the slit 52 are also holes penetrating the substrate 4. The slits 51, 52, 53, and 54 may be grooves with a bottom as illustrated in FIG. 3B. In addition, a part of the slits 51, 52, 53, and 54 may be a through-hole and the remaining part may be a groove.

The slits 51, 52, 53, and 54 have a function as a buffer portion that alleviates propagation of a physical bending stress as an external fluctuation.

Therefore, when a physical bending stress as an external fluctuation is applied to the inertial sensor module 100, the slits 51, 52, 53, and 54 can alleviate the stress transmitted to the first region 41 via the second region 42 and suppress the deformation of the first region 41.

As illustrated in FIGS. 1 and 2, the support portions 61, 62, 63, and 64 are portions between two adjacent slits formed by providing the slits 51, 52, 53, and 54.

The support portion 61 is a portion between the slit 51 and the slit 52. Similarly, the support portion 62 is a portion between the slit 52 and the slit 53, the support portion 63 is a portion between the slit 53 and the slit 54, and the support portion 64 is a portion between the slit 54 and the slit 51.

The support portions 61, 62, 63, and 64 surround the four sides of the first region 41. In other words, the support portions 61, 62, 63, and 64 surround the four sides of the first inertial sensor 1 and the second inertial sensor 2 mounted in the first region 41.

Further, the support portions 61, 62, 63, and 64 support the first region 41 from the second region 42 at four places on four sides of the first region 41. In other words, the support portions 61, 62, 63, and 64 couple the first region 41 and the second region 42.

In the present embodiment, the support portions 61, 62, 63, and 64 are provided in the vicinity of a center of each side of the first region 41. The positions where the support portions 61, 62, 63, and 64 are provided are not limited thereto. Other positions where the support portions 61, 62, 63, and 64 are provided will be described in a modification example described later.

The support portions 61, 62, 63, and 64 have a function as a buffer portion that alleviates the propagation of the physical bending stress as an external fluctuation.

Therefore, when the physical bending stress as an external fluctuation is applied to the inertial sensor module 100, the support portions 61, 62, 63, and 64 can alleviate the stress transmitted from the second region 42 to the first region 41 and suppress the deformation of the first region 41.

### 1.1.2. Regarding First Inertial Sensor and Second Inertial Sensor

The first inertial sensor 1 and the second inertial sensor 2 are inertial sensors that detect and output a physical quantity of a first axis, respectively. For example, when the physical quantity of the first axis is an angular velocity around the Z axis, the first inertial sensor 1 and the second inertial sensor 2 are angular velocity sensors that detect the angular velocity around the Z axis, respectively.

The first inertial sensor 1 and the second inertial sensor 2 are devices in which a sensor element that detects the physical quantity of the first axis is accommodated in a package, and each are configured as one chip. Preferably, the first inertial sensor 1 and the second inertial sensor 2 each accommodate a sensor element, a detection circuit, and an output circuit in a package.

When the first inertial sensor 1 and the second inertial sensor 2 are angular velocity sensors that detect the angular velocity around the Z axis, the sensor elements of the first inertial sensor 1 and the second inertial sensor 2 are sensor elements that detect the angular velocity around the Z axis, respectively.

The detection circuit of the first inertial sensor 1 performs detection processing on a signal output from the sensor element, and the output circuit outputs the signal obtained by the detection processing as a first detection signal.

The detection circuit of the second inertial sensor 2 performs detection processing on a signal output from the sensor element, and the output circuit outputs the signal obtained by the detection processing as a second detection signal.

The first inertial sensor 1 and the second inertial sensor 2 may have an A/D converter. The A/D converter generates a digital detection signal based on a signal of the physical quantity of the first axis output from the sensor element.

The physical quantity of the first axis is not limited to the angular velocity around the Z axis. The physical quantity of the first axis may be an angular velocity around the X axis, an angular velocity around the Y axis, an acceleration of the X axis, an acceleration of the Y axis, and an acceleration of the Z axis. Further, the inertial sensor module 100 may have three or more inertial sensors that detect the physical quantity of the first axis in the first region 41.

In addition, the first inertial sensor 1 and the second inertial sensor 2 may be either a single-axis inertial sensor or a multi-axis inertial sensor. In addition, the first inertial sensor 1 and the second inertial sensor 2 may be either the same type of inertial sensors or different types of inertial sensors. The single-axis inertial sensor, the multi-axis inertial sensor, the same type of inertial sensors, and the different types of inertial sensors will be described in an application configuration described later.

The first axis coincides with a direction of a detection axis a1 of the first inertial sensor 1 and a direction of a detection axis a2 of the second inertial sensor 2. The direction of the detection axis a1 and the direction of the detection axis a2 are appropriately set according to the use, purpose, and the like of the inertial sensor module 100. When the direction of the detection axis a1 and the direction of the detection axis a2 are determined, the direction of the detection axis a1 and the direction of the detection axis a2 become the first axis.

For example, when the inertial sensor module 100 is used for a moving object such as an automobile, it is preferable that the first axis be used as an axis for calculating a yaw angle. This is because, when performing posture control or position measurement of the moving object, it is particularly effective to accurately calculate the yaw angle among a roll angle, a pitch angle, and the yaw angle of the moving object for improving the accuracy. Here, when a traveling direction of the moving object is set as the X axis, a gravity direction of the moving object is set as the Z axis, and a direction orthogonal to the X axis and the Z axis is set as the Y axis, the yaw angle of the moving object is calculated by detecting the angular velocity around the Z axis.

Therefore, when the inertial sensor module 100 is used for the moving object, the direction of the detection axis a1 and the direction of the detection axis a2 may be provided to coincide with the Z axis. In this case, the Z axis is the first axis.

By aligning the direction of the detection axis a1 of the first inertial sensor 1 with the Z axis, the first inertial sensor 1 functions as a Z-axis angular velocity sensor that detects the angular velocity around the Z axis and outputs an angular velocity signal around the Z axis.

Similarly, by aligning the direction of the detection axis a2 of the second inertial sensor 2 with the Z axis, the second inertial sensor 2 functions as a Z-axis angular velocity sensor that detects the angular velocity around the Z axis and outputs an angular velocity signal around the Z axis.

The first inertial sensor 1 and the second inertial sensor 2 are provided on an upper surface of the first region 41 such that the direction of the detection axis a1 of the first inertial sensor 1 and the direction of the detection axis a2 of the second inertial sensor 2 coincide with the Z axis.

As described above, the inertial sensor module 100 of the present embodiment has two angular velocity sensors that detect the angular velocity around the Z axis, so that the redundancy of the sensor can be improved in detecting the angular velocity around the Z axis. Furthermore, the detection accuracy of the sensor can be improved in detecting the angular velocity around the Z axis.

Further, the inertial sensor module 100 of the present embodiment mounts the first inertial sensor 1 and the second inertial sensor 2 on the upper surface of the first region 41. As described above, the first region 41 suppresses the deformation even when the external fluctuation occurs.

Therefore, even when the external fluctuation occurs, it is possible to suppress the deviation of the direction of the detection axis a1 of the first inertial sensor 1 and/or the direction of the detection axis a2 of the second inertial sensor 2 from the Z axis, and to suppress the decrease in detection accuracy. In other words, by mounting the first inertial sensor 1 and the second inertial sensor 2 in the first region 41, the reliability of the detection accuracy is maintained or ensured even when the external fluctuation occurs.

The processing device 3 is, for example, an MCU, and is configured as a one-chip IC. The MCU is an abbreviation for a micro controller unit. The first inertial sensor 1 and the second inertial sensor 2 are coupled to the processing device 3 by a wiring of the substrate 4.

The processing device 3 performs reading processing of the first detection signal from the first inertial sensor 1 and the second detection signal from the second inertial sensor 2.

The processing device 3 receives the first detection signal output from the first inertial sensor 1, generates first detection data based on the first detection signal, receives the second detection signal output from the second inertial sensor 2, and generates second detection data based on the second detection signal.

The processing device 3 performs various arithmetic processing on the first detection signal and the second detection signal. The arithmetic processing is, for example, averaging processing. The processing device 3 may include a function of correcting temperature characteristics, misalignment, and the like.

### 1.1.3. Modification Examples

The above-described embodiment of the slits 51, 52, 53, and 54 can be variously modified. Specific modification aspects are illustrated below.

### 1.1.3.1. Modification Example 1

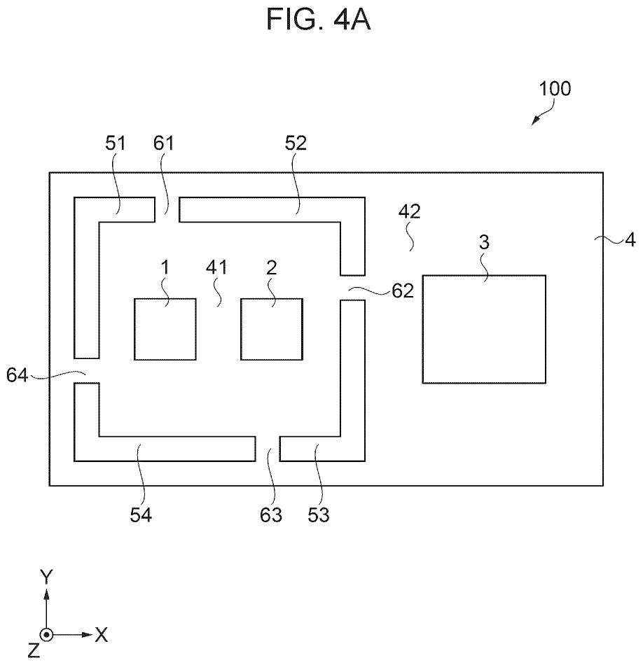

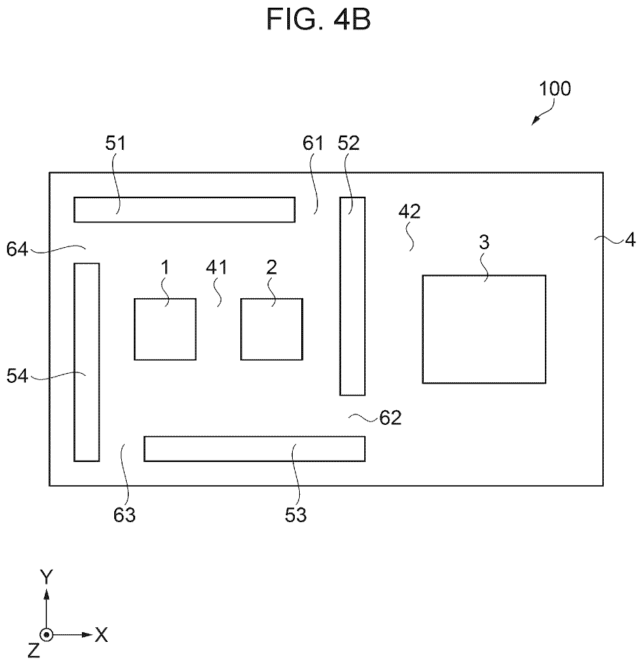

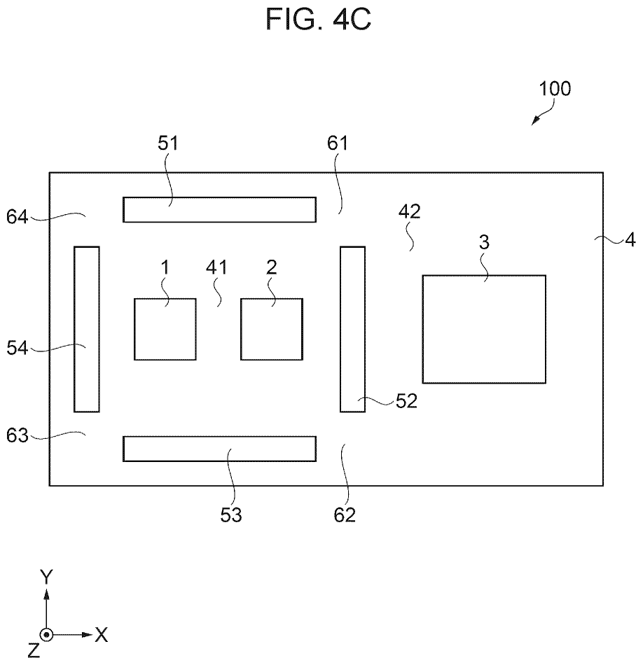

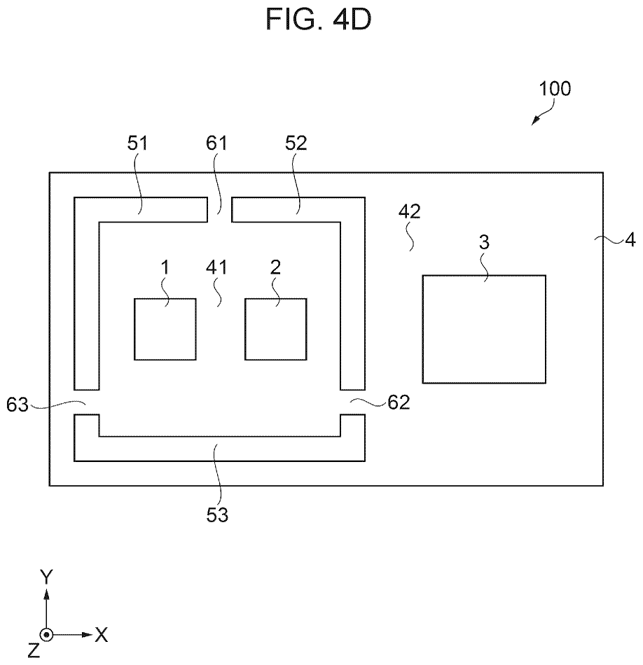

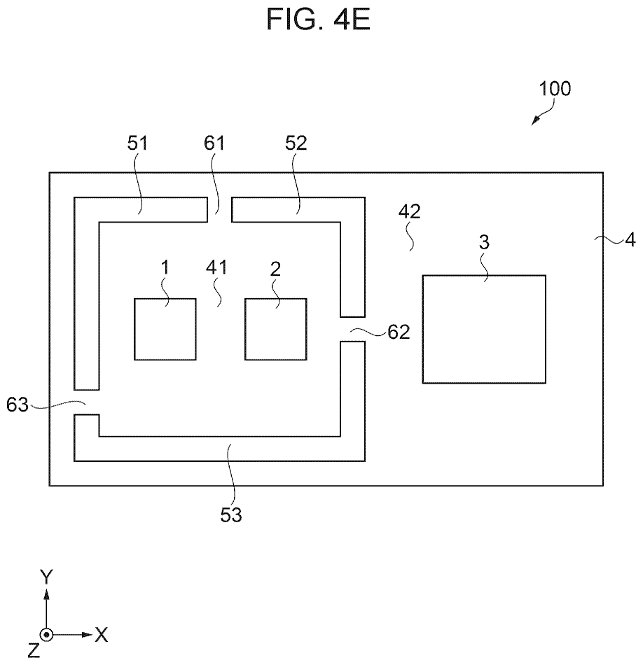

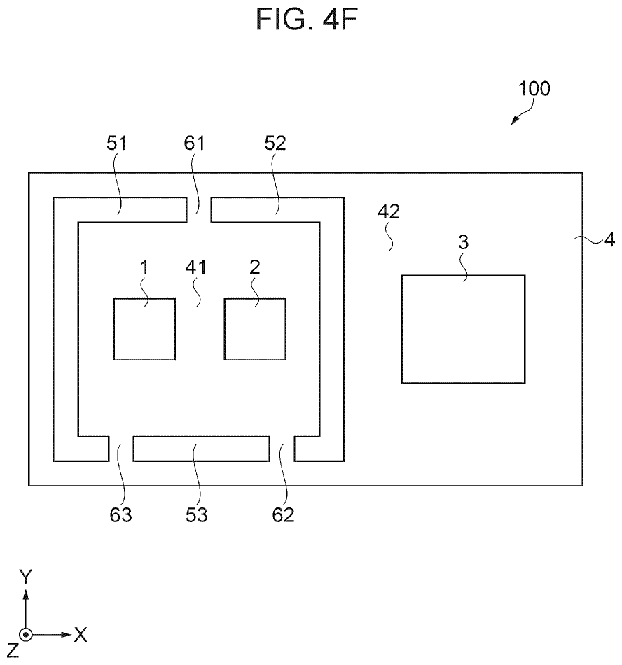

FIG. 4A is a plan view of an inertial sensor module according to Modification Example 1.

In the above-described embodiment, two sides constituting the slits 51, 52, 53, and 54 have substantially the same length, but in Modification Example 1, two sides constituting the slits 51, 52, 53, and 54 have lengths that differ by about multiple times.

Therefore, the support portions 61, 62, 63, and 64 are provided near different corners of four corners of the first region 41 having a rectangular shape.

### 1.1.3.2. Modification Example 2

FIG. 4B is a plan view of an inertial sensor module according to Modification Example 2.

In Modification Example 2, the slits 51, 52, 53, and 54 are provided in a straight line. Further, the slits 51, 52, 53, and 54 are provided along different sides from different corners of the four corners of the first region 41.

Therefore, the support portions 61, 62, 63, and 64 are provided near different corners of four corners of the first region 41 having a rectangular shape.

### 1.1.3.3. Modification Example 3

FIG. 4C is a plan view of an inertial sensor module according to Modification Example 3.

In Modification Example 3, the slits 51, 52, 53, and 54 are provided in a straight line. Further, the slits 51, 52, 53, and 54 are provided corresponding to different sides among the four sides of the first region 41 except for the four corners.

Therefore, the support portions 61, 62, 63, and 64 are provided at different corners of the four corners of the first region 41 having a rectangular shape.

### 1.1.3.4. Modification Example 4

FIG. 4D is a plan view of an inertial sensor module according to Modification Example 4.

Modification Example 4, and Modification Examples 5 and 6 to be described later have three slits 51, 52, and 53 as a plurality of slits. In Modification Examples 4, 5, and 6, the slits 51, 52, and 53 are examples of a plurality of slits, the slit 51 is an example of a first slit, the slit 52 is an example of a second slit, and the slit 53 is an example of a third slit.

The slits 51, 52, and 53 are provided between the first region 41 and the second region 42 and are provided along the first region 41 to surround the first region 41.

As a result, the first region 41 is surrounded on four sides by the slits 51, 52, and 53. In other words, the slits 51, 52, and 53 surround four sides of the first inertial sensor 1 and the second inertial sensor 2 mounted in the first region 41.

Further, Modification Example 4, and Modification Examples 5 and 6 to be described later have three support portions 61, 62, and 63. In Modification Examples 4, 5, and 6, the support portions 61, 62, and 63 are examples of a plurality of support portions, the support portion 61 is an example of a first support portion, the support portion 62 is an example of a second support portion, and the support portion 63 is an example of a third support portion.

The support portions 61, 62, and 63 are provided to surround three sides of the first region 41. In other words, the support portions 61, 62, and 63 surround three sides of the first inertial sensor 1 and the second inertial sensor 2 mounted in the first region 41. The three sides can be read as three sides of the four sides of the first region 41, three sides of the four sides of the first inertial sensor 1, or three sides of the four sides of the second inertial sensor 2.

Further, the support portions 61, 62, and 63 support the first region 41 from the second region 42 at three places on three sides of the first region 41. In other words, the support portions 61, 62, and 63 connect the first region 41 and the second region 42.

### 1.1.3.5. Modification Example 5

FIG. 4E is a plan view of an inertial sensor module according to Modification Example 5.

In Modification Example 5, three slits 51, 52, and 53 are provided as a plurality of slits. In Modification Example 5, lengths of the slits 51, 52, and 53 are different from each other. The length of the slit 52 is the shortest, and the length of the slit 53 is the longest. As a result, the support portion 62 is provided around the center of the side.

### 1.1.3.6. Modification Example 6

FIG. 4F is a plan view of an inertial sensor module according to Modification Example 6.

In Modification Example 6, three slits 51, 52, and 53 are provided as a plurality of slits. In Modification Example 6, lengths of the slit 51 and the slit 52 are the same as each other and longer than a length of the slit 53.

As a result, the support portion 62 and the support portion 63 are provided on the side opposite to the side on which the support portion 61 is provided.

### 1.2. Application Configuration of Inertial Sensor Module

### 1.2.1. Application Configuration 1

In the inertial sensor module 100 according to Application Configuration 1, the first inertial sensor 1 and the second inertial sensor 2 are different in type and the number of detection axes.

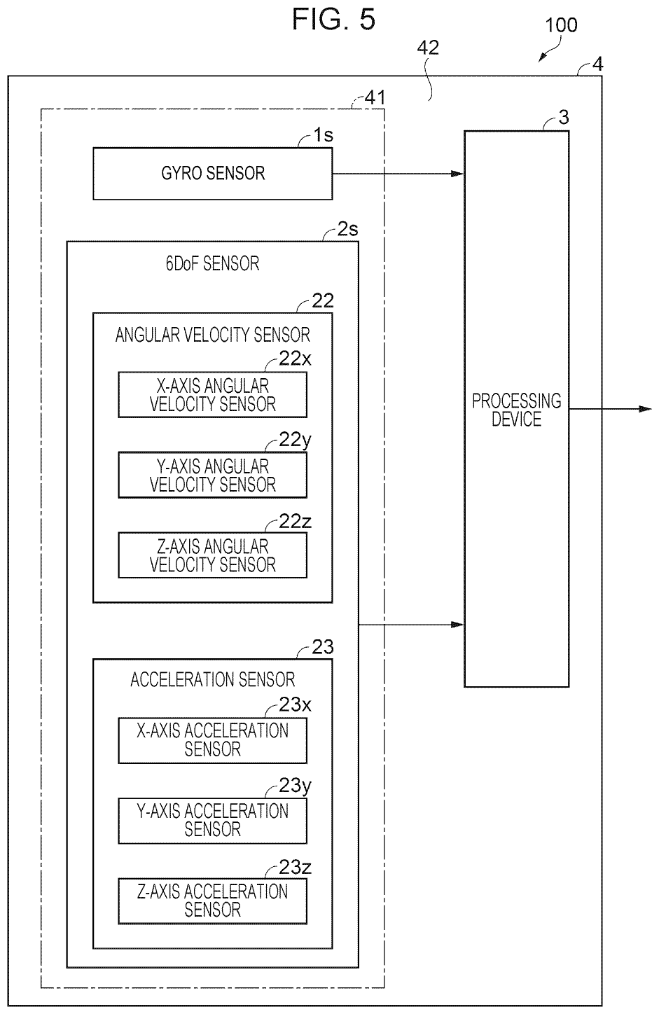

FIG. 5 is a block diagram illustrating a configuration of the inertial sensor module 100 according to Application Configuration 1.

The inertial sensor module 100 according to Application Configuration 1 includes a single-axis gyro sensor 1s as the first inertial sensor 1 and a multi-axis six-degree-of-freedom (6DoF) sensor 2s as the second inertial sensor 2.

The gyro sensor 1s and the 6DoF sensor 2s are mounted in the first region 41 of the substrate 4, and the processing device 3 is mounted in the second region 42 of the substrate 4.

The single-axis gyro sensor 1s is specifically a quartz crystal gyro that detects an angular velocity from a Coriolis force applied to a vibrating object, and is an angular velocity sensor having a higher accuracy than the second inertial sensor 2.

The 6DoF sensor 2s is a multi-axis inertial sensor that is equipped with a three-axis angular velocity sensor 22 and a three-axis acceleration sensor 23. In other words, the single-axis gyro sensor 1s and the 6DoF sensor 2s are different in the number of detection axes.

In the 6DoF sensor 2s, the angular velocity sensor 22 is a capacitance change-type silicon-micro electro mechanical systems (Si-MEMS) angular velocity sensor, and the acceleration sensor 23 is a capacitance change-type Si-MEMS acceleration sensor. In other words, the gyro sensor 1s and the 6DoF sensor 2s differ in the type of sensors.

The gyro sensor 1s may be a multi-sensor using a plurality of capacitance change-type Si-MEMS, a fiber optic gyro (FOG), or the like. In addition, the angular velocity sensor 22 of the 6DoF sensor 2s may be a quartz crystal gyro or the like, and the acceleration sensor 23 may be a quartz crystal acceleration sensor, a piezo-resistive acceleration sensor, and a thermosensitive acceleration sensor.

The angular velocity sensor 22 of the 6DoF sensor 2s includes an X-axis angular velocity sensor 22x, a Y-axis angular velocity sensor 22y, and a Z-axis angular velocity sensor 22z.

The X-axis angular velocity sensor 22x detects an angular velocity around the X-axis and outputs a first angular velocity signal. The Y-axis angular velocity sensor 22y detects an angular velocity around the Y-axis and outputs a second angular velocity signal. The Z-axis angular velocity sensor 22z detects an angular velocity around the Z-axis and outputs a third angular velocity signal.

The acceleration sensor 23 of the 6DoF sensor 2s includes an X-axis acceleration sensor 23x, a Y-axis acceleration sensor 23y, and a Z-axis acceleration sensor 23z.

The X-axis acceleration sensor 23x detects an acceleration in the X-axis direction and outputs a first acceleration signal. The Y-axis acceleration sensor 23y detects an acceleration in the Y-axis direction and outputs a second acceleration signal. The Z-axis acceleration sensor 23z detects an acceleration in the Z-axis direction and outputs a third acceleration signal.

The inertial sensor module 100 according to Application Configuration 1 can be used in, for example, the automobile described above.

In this case, the first axis is an axis for calculating the yaw angle, that is, the Z axis.

Therefore, the direction of the detection axis a1 of the gyro sensor 1s and the direction of the detection axis a2 of the Z-axis angular velocity sensor 22z are provided to coincide with the Z-axis. The first axis is not limited to the Z axis. The first axis may be appropriately set to the X axis or the Y axis according to the use, purpose, and the like.

In the inertial sensor module 100 according to Application Configuration 1, the gyro sensor 1s and the 6DoF sensor 2s are mounted in the first region 41, and the processing device 3 is mounted in the second region 42.

Therefore, according to the inertial sensor module 100 according to Application Configuration 1, even when an external fluctuation occurs, a decrease in detection accuracy of the gyro sensor 1s and/or the 6DoF sensor 2s is suppressed. Therefore, even when an external fluctuation occurs, the reliability of the detection accuracy of the inertial sensor module 100 is maintained or ensured.

Further, the inertial sensor module 100 according to Application Configuration 1 has a plurality of angular velocity sensors of the gyro sensor 1s and the Z-axis angular velocity sensor 22z as the angular velocity sensor that detects the angular velocity around the Z-axis, so that the redundancy of the sensor can be improved in detecting the angular velocity around the Z-axis.

Further, by using the single-axis gyro sensor 1s having a higher accuracy than the second inertial sensor 2, as the first inertial sensor 1, the detection accuracy can be improved. Regarding this point, the present applicant has found through experiments of the present inventors that the detection accuracy can be improved by using the single-axis gyro sensor 1s and the 6DoF sensor 2s compared to when they are used alone.

Furthermore, the inertial sensor module 100 including the single-axis gyro sensor 1s and the 6DoF sensor 2s is less expensive than a three-axis quartz crystal gyro sensor, but can realize the same detection accuracy as the expensive three-axis quartz crystal gyro sensor. Therefore, it is possible to realize the inertial sensor module 100 which is highly practical and has a high industrial utility value.

### 1.2.2. Application Configuration 2

In the inertial sensor module 100 according to Application Configuration 2, the first inertial sensor 1 and the second inertial sensor 2 are the same in type and/or the number of detection axes.

Specifically, the inertial sensor module 100 according to Application Configuration 2 includes the 6DoF sensor 2s as the first inertial sensor 1 and the 6DoF sensor 2s as the second inertial sensor 2.

Alternatively, the inertial sensor module 100 according to Application Configuration 2 includes the single-axis gyro sensor 1s as the first inertial sensor 1 and the single-axis gyro sensor 1s as the second inertial sensor 2.

Alternatively, the inertial sensor module 100 according to Application Configuration 2 includes the three-axis angular velocity sensor as the first inertial sensor 1 and the three-axis angular velocity sensor as the second inertial sensor 2.

Alternatively, the inertial sensor module 100 according to Application Configuration 2 includes the three-axis acceleration sensor as the first inertial sensor 1 and the three-axis acceleration sensor as the second inertial sensor 2.

In the inertial sensor module 100 according to Application Configuration 2, the first axis may be any of the X axis, the Y axis, and the Z axis.

In addition, in the inertial sensor module 100 according to Application Configuration 2, the physical quantity of the first axis detected by the first inertial sensor 1 and the second inertial sensor 2 may be any of an angular velocity around the X axis, an angular velocity around the Y axis, an angular velocity around the Z axis, an acceleration in the X-axis direction, an acceleration in the Y-axis direction, and an acceleration in the Z-axis direction.

The inertial sensor module 100 according to Application Configuration 2 has two inertial sensors of the first inertial sensor 1 and the second inertial sensor 2, but may have three or more inertial sensors.

As described above, according to the inertial sensor module 100 of the present embodiment, the following effects can be obtained.

The inertial sensor module 100 of the present embodiment includes the first inertial sensor 1 that detects the angular velocity around the Z axis as the physical quantity of the first axis, the second inertial sensor 2 that detects the angular velocity around the Z axis, and the substrate 4 including the first region 41 in which the first inertial sensor 1 and the second inertial sensor 2 are mounted, the second region 42 surrounding the first region 41, and the slits 51, 52, 53, and 54 as a plurality of slits provided between the first region 41 and the second region 42 to surround the first region 41.

As described above, the inertial sensor module 100 has the first region 41 of which a periphery is surrounded by the slits 51, 52, 53, and 54, and the first inertial sensor 1 and the second inertial sensor 2 that detect the angular velocity around the Z axis are mounted in the first region 41.

Therefore, the inertial sensor module 100 of the present embodiment can suppress a decrease in reliability of the detection accuracy of the first inertial sensor 1 and/or the second inertial sensor 2 even when an external fluctuation such as application of a bending stress or a temperature change occurs. Therefore, according to the inertial sensor module 100 of the present embodiment, even when the external fluctuation occurs, the reliability of the detection accuracy of the inertial sensor module 100 is maintained or ensured.

Further, in the inertial sensor module 100 of the present embodiment, the substrate 4 includes a connector 8, which will be described later, as an external coupling portion provided in the second region 42.

Therefore, it is possible to alleviate the external fluctuation transmitted via the connector 8.

Further, the inertial sensor module 100 of the present embodiment further includes the processing device 3 provided in the second region 42 and processing the first detection signal from the first inertial sensor 1 and the second detection signal from the second inertial sensor 2.

As described above, the second region 42 includes the processing device 3.

Therefore, it is possible to alleviate an influence of an external fluctuation from the processing device 3 as a heat source. Therefore, the inertial sensor module 100 of the present embodiment can output a calculation result with high reliability.

Further, in the inertial sensor module 100 of the present embodiment, the slits 51, 52, 53, and 54 as a plurality of slits are provided to surround the four sides of the first inertial sensor 1 as a first inertial sensor and the second inertial sensor 2 as a second inertial sensor.

Therefore, the inertial sensor module 100 of the present embodiment can suppress a decrease in reliability of the detection accuracy of the first inertial sensor 1 and/or the second inertial sensor 2 even when an external fluctuation occurs.

Further, in the inertial sensor module 100 of the present embodiment, the substrate 4 includes the support portions 61, 62, 63, and 64 as a plurality of support portions provided between the slits 51, 52, 53, and 54 as a plurality of slits, and the support portions 61, 62, 63, and 64 are provided to surround three or four sides of the first inertial sensor 1 as a first inertial sensor and the second inertial sensor 2 as a second inertial sensor.

Therefore, the inertial sensor module 100 of the present embodiment can suppress a decrease in reliability of the detection accuracy of the first inertial sensor 1 and/or the second inertial sensor 2 even when an external fluctuation occurs.

Further, in the inertial sensor module 100 of the present embodiment, the slits 51, 52, 53, and 54 as a plurality of slits include the slit 51 as a first slit, the slit 52 as a second slit, the slit 53 as a third slit, and the slit 54 as a fourth slit, and the support portions 61, 62, 63, and 64 as a plurality of support portions include the support portion 61 as a first support portion provided between the slit 51 and the slit 52, the support portion 62 as a second support portion provided between the slit 52 and the slit 53, the support portion 63 as a third support portion provided between the slit 53 and the slit 54, and the support portion 64 as a fourth support portion provided between the slit 54 and the slit 51.

As described above, the first region 41 is supported by the support portions 61, 62, 63, and 64 at four places on four sides from the second region 42.

Therefore, the inertial sensor module 100 of the present embodiment can suppress a decrease in reliability of the detection accuracy of the first inertial sensor 1 and/or the second inertial sensor 2 even when an external fluctuation occurs.

Further, in the inertial sensor module 100 of the present embodiment, the slits 51, 52, and 53 as a plurality of slits include the slit 51 as a first slit, the slit 52 as a second slit, and the slit 53 as a third slit, and the support portions 61, 62, and 63 as a plurality of support portions include the support portion 61 as a first support portion provided between the slit 51 and the slit 52, the support portion 62 as a second support portion provided between the slit 52 and the slit 53, and the support portion 63 as a third support portion provided between the slit 53 and the slit 51.

As described above, the first region 41 is supported by the support portions 61, 62, and 63 at three places on three sides from the second region 42.

Therefore, the inertial sensor module 100 of the present embodiment can suppress a decrease in reliability of the detection accuracy of the first inertial sensor 1 and/or the second inertial sensor 2 even when an external fluctuation occurs.

### 2. Embodiment 2

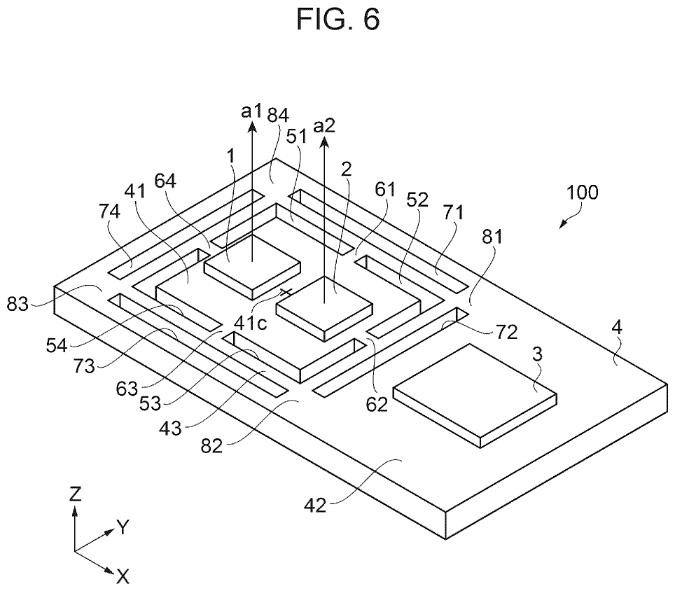

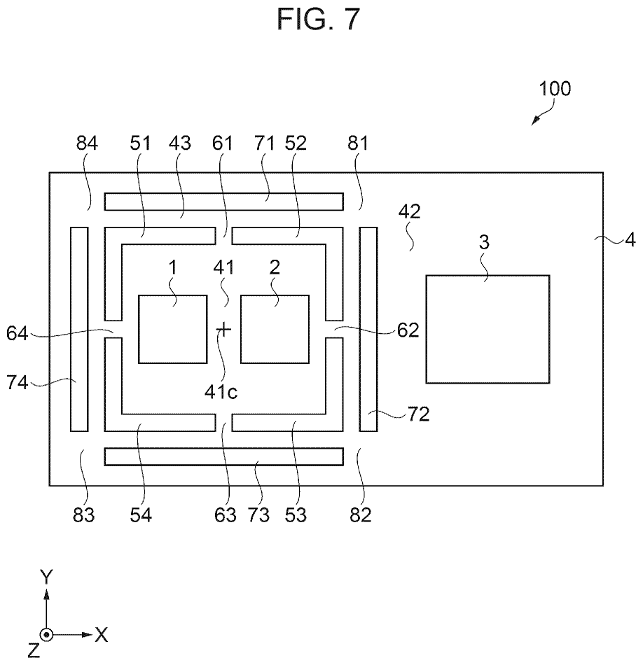

A configuration of the inertial sensor module 100 according to Embodiment 2 will be described with reference to FIGS. 6 and 7.

FIG. 6 is a perspective view of the inertial sensor module according to Embodiment 2. FIG. 7 is a plan view of the inertial sensor module according to Embodiment 2.

### 2.1. Configuration of Inertial Sensor Module

The inertial sensor module 100 of Embodiment 2 is different from that of Embodiment 1 in that it has double slits surrounding the first region 41. The same or similar components as those in Embodiment 1 are denoted by the same reference numerals, and the description thereof will not be repeated.

In FIGS. 6 and 7, the substrate 4 has a first region 41, a second region 42, a third region 43, slits 51, 52, 53, and 54, support portions 61, 62, 63, and 64, slits 71, 72, 73, and 74, and support portions 81, 82, 83, and 84. In Embodiment 2, the slits 51, 52, 53, and 54 are examples of a first plurality of slits, the slit 51 is an example of a first slit, the slit 52 is an example of a second slit, the slit 53 is an example of a third slit, and the slit 54 is an example of a fourth slit. Further, the support portions 61, 62, 63, and 64 are examples of a first plurality of support portions, the support portion 61 is an example of a first support portion, the support portion 62 is an example of a second support portion, the support portion 63 is an example of a third support portion, and the support portion 64 is an example of a fourth support portion.

The third region 43 is located between the first region 41 and the second region 42. In other words, the third region 43 surrounds the first region 41, and the second region 42 surrounds the third region 43.

The first inertial sensor 1 and the second inertial sensor 2 are mounted in the first region 41. The processing device 3 is mounted in the second region 42.

The slits 51, 52, 53, and 54 are provided between the first region 41 and the third region 43. The slits 51, 52, 53, and 54 are provided along a periphery of the first region 41 to surround the first region 41. In other words, the first region 41 is surrounded on four sides by the slits 51, 52, 53, and 54.

Further, the slits 51, 52, 53, and 54 surround four sides of the first inertial sensor 1 and the second inertial sensor 2.

The slits 51, 52, 53, and 54 each have a shape having two sides of a right-angled isosceles triangle intersecting each other at a right angle, as in Embodiment 1. The shape of the slits 51, 52, 53, and 54 is not limited thereto. The other shapes of the slits 51, 52, 53, and 54 will be described in a modification example described later. The support portions 61, 62, 63, and 64 support the first region 41 from the third region 43 at four places on four sides of the first region 41. In other words, the support portions 61, 62, 63, and 64 couple the first region 41 and the third region 43.

The support portions 61, 62, 63, and 64 are provided in the vicinity of a center of each side of the first region 41, as in Embodiment 1. The positions where the support portions 61, 62, 63, and 64 are provided are not limited thereto. Other positions where the support portions 61, 62, 63, and 64 are provided will be described in a modification example described later.

The slits 71, 72, 73, and 74 are provided between the third region 43 and the second region 42. The slits 71, 72, 73, and 74 are provided along a periphery of the third region 43 to surround the third region 43. In other words, the third region 43 is surrounded on four sides by the slits 71, 72, 73, and 74.

Further, the slits 71, 72, 73, and 74 surround four sides of the first inertial sensor 1 and the second inertial sensor 2.

The slits 71, 72, 73, and 74 are provided in a straight line. The shape of the slits 71, 72, 73, and 74 is not limited thereto. The other shapes of the slits 71, 72, 73, and 74 will be described in a modification example described later.

Although not illustrated, the slits 71, 72, 73, and 74 are preferably holes penetrating the substrate 4, similarly to the slits 51, 52, 53, and 54. The slits 71, 72, 73, and 74 may be grooves with a bottom. In addition, a part of the slits 51, 52, 53, and 54 and the slits 71, 72, 73, and 74 may be a through-hole, and the remaining part may be a groove.

The slits 51, 52, 53, and 54 and the slits 71, 72, 73, and 74 have a function as a buffer portion that alleviates propagation of a physical bending stress as an external fluctuation.

Therefore, when a physical bending stress as an external fluctuation is applied to the inertial sensor module 100, the slits 71, 72, 73, and 74 can alleviate the stress transmitted to the third region 43 via the second region 42 and suppress the deformation of the third region 43 and the first region 41. The slits 51, 52, 53, and 54 can alleviate the stress transmitted to the first region 41 via the third region 43 and suppress the deformation of the first region 41.

As illustrated in FIGS. 6 and 7, the support portions 81, 82, 83, and 84 are portions between two adjacent slits formed by providing the slits 71, 72, 73, and 74.

The support portion 81 is a portion between the slit 71 and the slit 72. Similarly, the support portion 82 is a portion between the slit 72 and the slit 73, the support portion 83 is a portion between the slit 73 and the slit 74, and the support portion 84 is a portion between the slit 74 and the slit 71.

The support portions 81, 82, 83, and 84 surround the four sides of the third region 43. In other words, the support portions 81, 82, 83, and 84 surround the four sides of the first inertial sensor 1 and the second inertial sensor 2 mounted in the first region 41 surrounded by the third region 43.

The support portions 81, 82, 83, and 84 are provided near different corners of four corners of the third region 43.

Further, the support portions 81, 82, 83, and 84 are provided at positions that do not overlap the support portions 61, 62, 63, and 64 when viewed from a center 41c of the first region 41. The positions where the support portions 81, 82, 83, and 84 are provided are not limited thereto. Other positions where the support portions 81, 82, 83, and 84 are provided will be described in a modification example described later.

The support portions 61, 62, 63, and 64 and the support portions 81, 82, 83, and 84 have a function as a buffer portion that alleviates the propagation of the physical bending stress as an external fluctuation.

Therefore, when the physical bending stress as an external fluctuation is applied to the inertial sensor module 100, the support portions 81, 82, 83, and 84 can alleviate the stress transmitted from the second region 42 to the third region 43 and suppress the deformation of the third region 43 and the first region 41. In addition, the support portions 61, 62, 63, and 64 can alleviate the stress transmitted from the third region 43 to the first region 41 and suppress the deformation of the first region 41.

Further, when viewed from the center 41c of the first region 41, the support portions 61, 62, 63, and 64 and the support portions 81, 82, 83, and 84 do not overlap each other, and thus, the heat and stress transmitted from the second region 42 to the first region 41 can be alleviated compared to when the support portions 61, 62, 63, and 64 and the support portions 81, 82, 83, and 84 overlap each other. In other words, the support portion 61 is disposed not located on a straight line connecting the center 41c of the first region 41 and the support portion 81, the support portion 62 is disposed not to be located on a straight line connecting the center 41c of the first region 41 and the support portion 82, the support portion 63 is disposed not to be located on a straight line connecting the center 41c of the first region 41 and the support portion 83, and the support portion 64 is disposed not to be located on a straight line connecting the center 41c of the first region 41 and the support portion 84.

### 2.2. Modification Examples

In Embodiment 2, embodiments of the slits 51, 52, 53, and 54 and the slits 71, 72, 73, and 74 can be variously modified. Specific modification aspects are illustrated below.

### 2.2.1. Modification Example 7

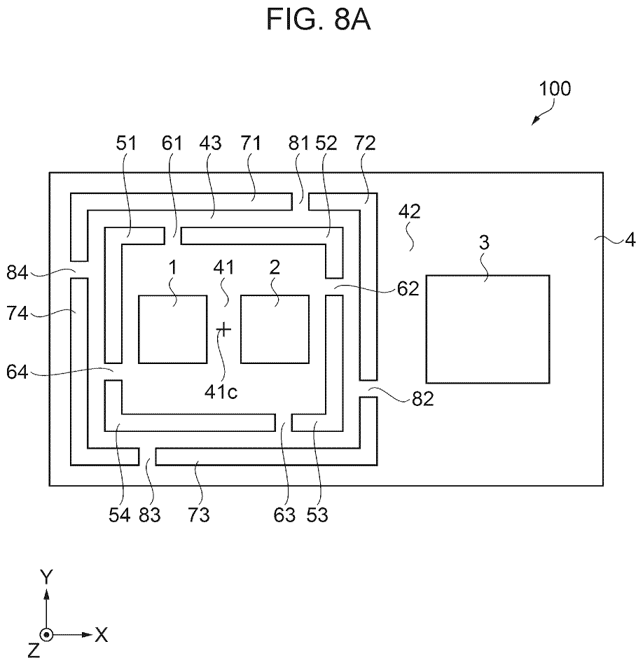

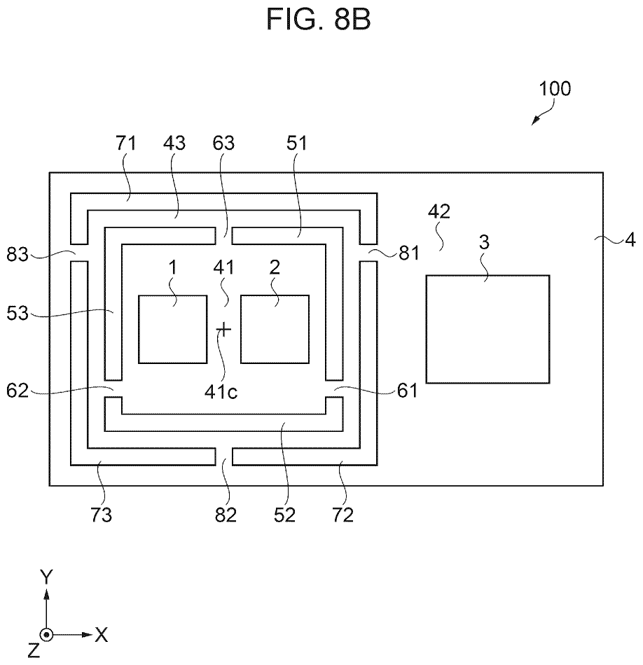

FIG. 8A is a plan view of the inertial sensor module 100 according to Modification Example 7.

The slits 51, 52, 53, and 54 are substantially similar to the slits 51, 52, 53, and 54 illustrated in FIG. 4A. The slits 71, 72, 73, and 74 are substantially similar to shapes obtained by horizontally inverting the slits 51, 52, 53, and 54.

### 2.2.2. Modification Example 8

FIG. 8B is a plan view of the inertial sensor module 100 according to Modification Example 8.

The slits 51, 52, and 53 are substantially similar to the slits 51, 52, and 53 illustrated in FIG. 4D. The slits 71, 72, and 73 are substantially similar to shapes obtained by vertically inverting the slits 51, 52, and 53.

### 2.2.3. Modification Example 9

Although not illustrated, in Modification Example 7 or 8, the slits 51, 52, 53, and 54 or the slits 51, 52, and 53 may adopt any of the above-described forms. In addition, the slits 71, 72, 73, and 74 or the slits 71, 72, and 73 may adopt any of the above-described forms. It is preferable that the support portions 61, 62, 63, and 64 or the support portions 61, 62, and 63, and the support portions 81, 82, 83, and 84 or the support portions 81, 82, and 83 are located at portions that do not overlap each other when viewed from the center 41c of the first region 41.

Further, the first region 41 may be surrounded by three or more types of slits by providing slits surrounding the slits 71, 72, 73, and 74 or the slits 71, 72, and 73.

As described above, according to the inertial sensor module 100 of Embodiment 2, in addition to the effects of Embodiment 1, the following effects can be obtained.

The inertial sensor module 100 of Embodiment 2 includes the first inertial sensor 1 as a first inertial sensor that detects the angular velocity around the Z axis as the physical quantity of the first axis, the second inertial sensor 2 that detecting the angular velocity around the Z axis, the substrate 4 including the first region 41 in which the first inertial sensor 1 and the second inertial sensor 2 are mounted, the second region 42 surrounding the first region 41, the third region 43 surrounding the first region 41 between the first region 41 and the second region 42, the slits 51, 52, 53, and 54 as a first plurality of slits provided between the first region 41 and the third region 43 to surround the first region 41, and the slits 71, 72, 73, and 74 as a second plurality of slits provided between the third region 43 and the second region 42 to surround the third region 43.

As described above, the inertial sensor module 100 includes the first region 41 surrounded by the slits 51, 52, 53, and 54 and the third region 43 surrounding the first region 41 and surrounded by the slits 71, 72, 73, and 74, and the first inertial sensor 1 and the second inertial sensor 2 that detect the angular velocity around the Z axis are mounted in the first region 41.

Therefore, the inertial sensor module 100 of Embodiment 2 can suppress a decrease in reliability of the detection accuracy of the first inertial sensor 1 and/or the second inertial sensor 2 even when an external fluctuation such as application of a bending stress or a temperature change occurs. Therefore, according to the inertial sensor module 100 of the present embodiment, even when the external fluctuation occurs, the reliability of the detection accuracy of the inertial sensor module 100 is maintained or ensured.

Further, in the inertial sensor module 100 of Embodiment 2, the substrate 4 includes a connector 8, which will be described later, as an external coupling portion provided in the second region 42.

Therefore, it is possible to alleviate the external fluctuation transmitted via the connector 8.

The inertial sensor module 100 of Embodiment 2 further includes the processing device 3 provided in the second region 42 and processing the first detection signal of the first inertial sensor 1 as a first inertial sensor and the second detection signal of the second inertial sensor 2 as a second inertial sensor.

As described above, the second region 42 includes the processing device 3.

Therefore, it is possible to alleviate an influence of an external fluctuation from the processing device 3 as a heat source. Therefore, the inertial sensor module 100 of Embodiment 2 can output a calculation result with high reliability.

Further, in the inertial sensor module 100 of Embodiment 2, the slits 51, 52, 53, and 54 as a first plurality of slits and the slits 71, 72, 73, and 74 as a second plurality of slits are provided to surround four sides of the first inertial sensor 1 as a first inertial sensor and the second inertial sensor 2 as a second inertial sensor.

Therefore, the inertial sensor module 100 of the present embodiment can suppress a decrease in reliability of the detection accuracy of the first inertial sensor 1 and/or the second inertial sensor 2 even when an external fluctuation occurs.

Further, in the inertial sensor module 100 of the present embodiment, the substrate 4 includes the support portions 61, 62, 63, and 64 as a first plurality of support portions provided between the slits 51, 52, 53, and 54 as a first plurality of slits, and the support portions 61, 62, 63, and 64 overlap any of the slits 71, 72, 73, and 74 when viewed from the center 41c of the first region 41.

Therefore, the inertial sensor module 100 of the present embodiment can suppress a decrease in reliability of the detection accuracy of the first inertial sensor 1 and/or the second inertial sensor 2 even when an external fluctuation occurs.

Further, in the inertial sensor module 100 of the present embodiment, the substrate 4 includes the support portions 81, 82, 83, and 84 as a second plurality of support portions provided between the slits 71, 72, 73, and 74 as a second plurality of slits, and the support portions 61, 62, 63, and 64 do not overlap any of the support portions 81, 82, 83, and 84 when viewed from the center 41c of the first region 41.

Therefore, the inertial sensor module 100 of the present embodiment can suppress a decrease in reliability of the detection accuracy of the first inertial sensor 1 and/or the second inertial sensor 2 even when an external fluctuation occurs.

Further, in the inertial sensor module 100 of the present embodiment, the substrate 4 includes the support portions 61, 62, 63, and 64 as a first plurality of support portions provided between the slits 51, 52, 53, and 54 as a first plurality of slits, and the support portions 81, 82, 83, and 84 as a second plurality of support portions provided between the slits 71, 72, 73, and 74 as a second plurality of slits, and the support portions 61, 62, 63, and 64 and the support portions 81, 82, 83, and 84 are provided to surround three or four sides of the first inertial sensor 1 as a first inertial sensor and the second inertial sensor 2 as a second inertial sensor.

Therefore, the inertial sensor module 100 of the present embodiment can suppress a decrease in reliability of the detection accuracy of the first inertial sensor 1 and/or the second inertial sensor 2 even when an external fluctuation occurs.

Further, in the inertial sensor module 100 of the present embodiment, the slits 51, 52, 53, and 54 as a first plurality of slits include the slit 51 as a first slit, the slit 52 as a second slit, the slit 53 as a third slit, and the slit 54 as a fourth slit, the support portions 61, 62, 63, and 64 as a first plurality of support portions include the support portion 61 as a first support portion provided between the slit 51 and the slit 52, the support portion 62 as a second support portion provided between the slit 52 and the slit 53, the support portion 63 as a third support portion provided between the slit 53 and the slit 54, and the support portion 64 as a fourth support portion provided between the slit 54 and the slit 51, the slits 71, 72, 73, and 74 as a second plurality of slits include the slit 71 as a fifth slit, the slit 72 as a sixth slit, the slit 73 as a seventh slit, and the slit 74 as an eighth slit, and the support portions 81, 82, 83, and 84 as a second plurality of support portions include the support portion 81 as a fifth support portion provided between the slit 71 and the slit 72, the support portion 82 as a sixth support portion provided between the slit 72 and the slit 73, the support portion 83 as a seventh support portion provided between the slit 73 and the slit 74, and the support portion 84 as an eighth support portion provided between the slit 74 and the slit 71.

As described above, the first region 41 is supported by the support portions 61, 62, 63, and 64 at four places on four sides from the third region 43, and the third region 43 is supported by the support portions 81, 82, 83, and 84 at four places on four sides from the second region 42.

Therefore, the inertial sensor module 100 of the present embodiment can suppress a decrease in reliability of the detection accuracy of the first inertial sensor 1 and/or the second inertial sensor 2 even when an external fluctuation occurs.

Further, in the inertial sensor module 100 of the present embodiment, the slits 51, 52, and 53 as a first plurality of slits include the slit 51 as a first slit, the slit 52 as a second slit, and the slit 53 as a third slit, the support portions 61, 62, and 63 as a first plurality of support portions include the support portion 61 as a first support portion provided between the slit 51 and the slit 52, the support portion 62 as a second support portion provided between the slit 52 and the slit 53, and the support portion 63 as a third support portion provided between the slit 53 and the slit 51, the slits 71, 72, and 73 as a second plurality of slits include the slit 71 as a fourth slit, the slit 72 as a fifth slit, and the slit 73 as a sixth slit, and the support portions 81, 82, and 83 as a second plurality of support portions include the support portion 81 as a fourth support portion provided between the slit 71 and the slit 72, the support portion 82 as a fifth support portion provided between the slit 72 and the slit 73, and the support portion 83 as a sixth support portion provided between the slit 73 and the slit 71.

As described above, the first region 41 is supported by the support portions 61, 62, and 63 at three places on three sides from the third region 43, and the third region 43 is supported by the support portions 81, 82, and 83 at three places on the three sides from the second region 42.

Therefore, the inertial sensor module 100 of the present embodiment can suppress a decrease in reliability of the detection accuracy of the first inertial sensor 1 and/or the second inertial sensor 2 even when an external fluctuation occurs.

### 3. Embodiment 3

In Embodiment 3, an inertial measurement unit (IMU) 200 including the inertial sensor module 100 will be described.

### 3.1. Overview of Inertial Measurement Unit

The inertial measurement unit 200 is mounted on a mounting device, for example, an automobile, a smartphone, or the like, and is used to detect a posture or behavior of the mounting device.

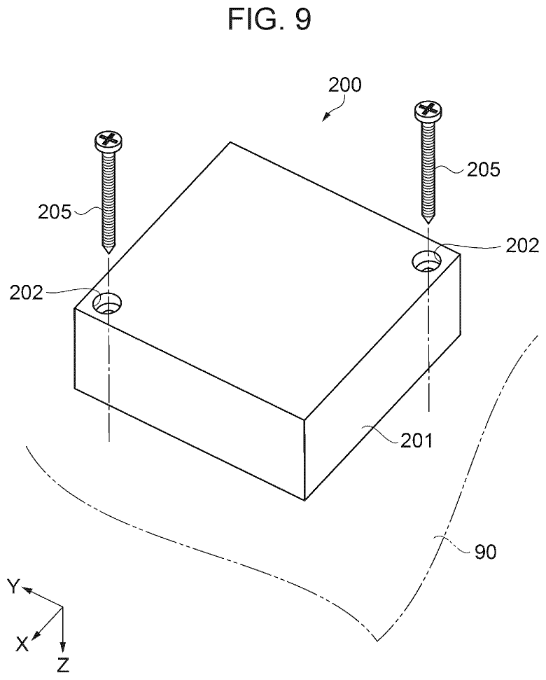

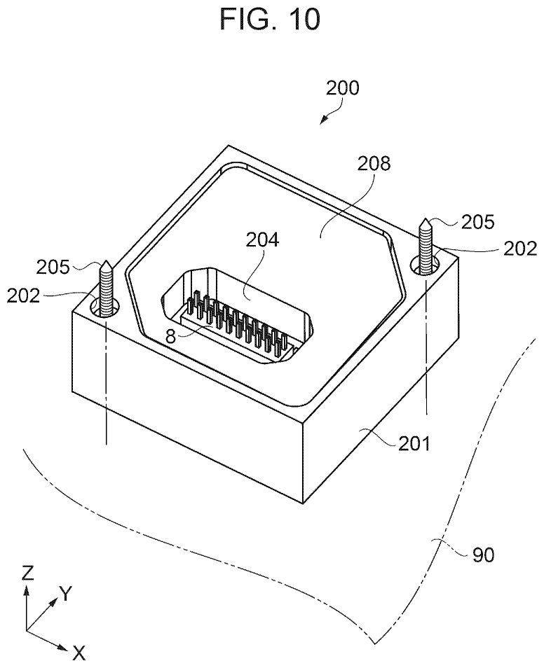

FIG. 9 is a perspective view of the inertial measurement unit 200 according to Embodiment 3, and is a view illustrating a state in which the inertial measurement unit 200 is fixed to a mounting surface 90 of the mounting device. FIG. 10 is a perspective view of the inertial measurement unit 200 as viewed from the mounting surface 90 side.

In Embodiment 3, the inertial measurement unit 200 is a rectangular parallelepiped having a square planar shape, and screw holes 202 as fixing portions are formed near two vertices located in a diagonal direction of a square. The inertial measurement unit 200 is used by being fixed to the mounting surface 90 of the mounting device by screws 205 passed through the screw holes 202. The shape and the fixing method of the inertial measurement unit 200 described above are examples, and suitable shapes and fixing methods can be adopted depending on the intended use and the like.

As illustrated in FIG. 10, an opening portion 204 is formed at a surface of the inertial measurement unit 200 on the mounting surface 90 side. The plug-type connector 8 is disposed inside the opening portion 204.

The connector 8 has a plurality of pins disposed in parallel. A socket-type connector (not illustrated) is coupled to the connector 8 from the mounting device. An electric signal is transmitted and received between the inertial measurement unit 200 and the mounting device via the connector 8, the electric signal including power supply to the inertial measurement unit 200, detection data output to the mounting device, and the like.

### 3.2. Configuration of Inertial Measurement Unit

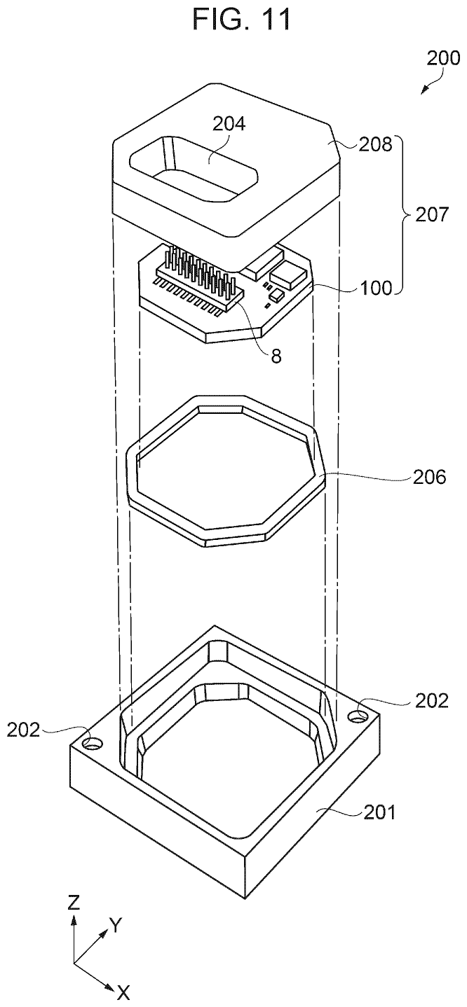

FIG. 11 is an exploded perspective view of the inertial measurement unit 200, and is an exploded perspective view of the inertial measurement unit 200 as viewed from the same direction as in FIG. 10.

As illustrated in FIG. 11, the inertial measurement unit 200 includes an outer case 201, an annular buffer material 206, and an inertial sensor unit 207. In other words, the inertial measurement unit 200 includes the inertial sensor unit 207 mounted inside the outer case 201 with the annular buffer material 206 interposed therebetween. The inertial sensor unit 207 includes an inner case 208 and the inertial sensor module 100.

The outer shape of the outer case 201 is a rectangular parallelepiped having a square planar shape, and the screw holes 202 are formed near two vertices located in a diagonal direction of a square. The planar shape of the outer case 201 may be, for example, a polygon such as a hexagon or an octagon.

### 3.3. Configuration of Inertial Sensor Module

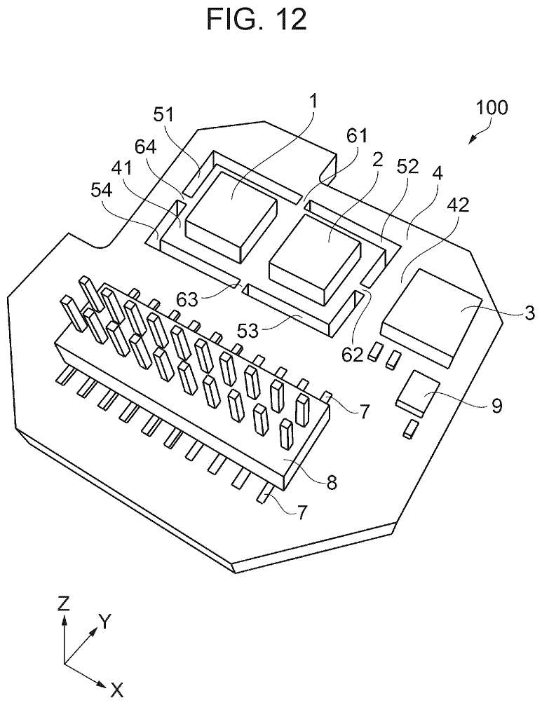

FIG. 12 is a perspective view of the inertial sensor module 100 mounted on the inertial measurement unit 200.

The inertial sensor module 100 according to Embodiment 3 is different from the inertial sensor module 100 according to Embodiment 1 in that the substrate 4 includes the connector 8, a global positioning system (GPS) module 9, and other circuit components. The same components as those in Embodiment 1 are denoted by the same reference numerals, and the description thereof will not be repeated.

The substrate 4 has the first region 41 and the second region 42. The first inertial sensor 1 and the second inertial sensor 2 are mounted in the first region 41, and the processing device 3, the connector 8, the GPS module 9, and other circuit components are mounted in the second region 42. In the present embodiment, the connector 8 is an example of an external coupling portion.

The connector 8 is a plug-type connector, and is provided with external coupling terminals 7 formed of a plurality of pins. Further, the connector 8 is not limited to such a form. For example, the connector 8 may be a lead, a coupling electrode, an optical connector, or a non-contact connector.

The inertial sensor module 100 may have a temperature sensor, a magnetic sensor, a capacitor, or the like. When the temperature sensor or the magnetic sensor is mounted, the temperature sensor or the magnetic sensor is mounted in the first region 41. This is because, when the temperature sensor or the magnetic sensor is disposed close to the first inertial sensor 1 and the second inertial sensor 2, the measurement can be performed accurately.

As described above, the inertial measurement unit 200 of Embodiment 3 includes the inertial sensor module 100. The inertial sensor module 100 maintains or ensures the reliability of the detection accuracy even when an external fluctuation such as application of a bending stress or a temperature change is applied.

Therefore, according to the inertial measurement unit 200 of Embodiment 3, it is possible to realize the inertial measurement unit 200 with which the reliability of the detection accuracy is maintained or ensured when an external fluctuation is applied.

### 4. Embodiment 4

In Embodiment 4, an electronic apparatus including the inertial sensor module 100 will be described.

In the following, as examples of the electronic apparatus, an example of a moving object such as an automobile and an example of a portable device such as a smartphone will be described.

### 4.1. Overview of Moving Object

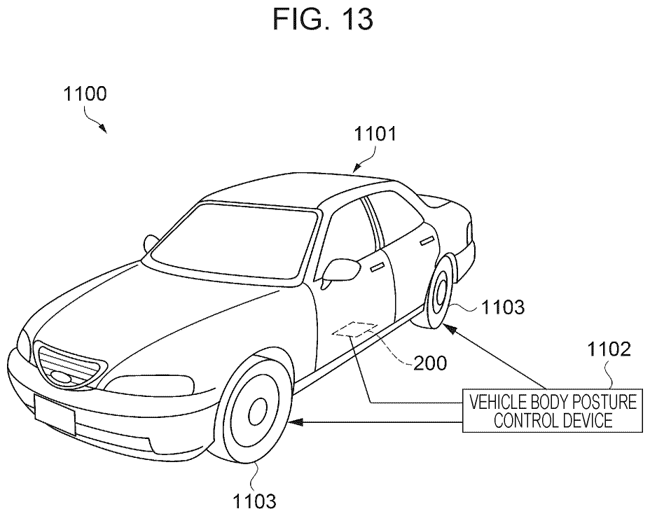

FIG. 13 is a perspective view of a moving object as an electronic apparatus according to Embodiment 4, and is a view illustrating a configuration of an automobile 1100 as an example of the moving object.

The automobile 1100 is equipped with the inertial measurement unit 200 including the inertial sensor module 100.

The inertial measurement unit 200 detects a posture of a vehicle body 1101 and outputs a detection signal. The detection signal includes an angular velocity signal and an acceleration signal. The detection signal of the inertial measurement unit 200 is supplied to a vehicle body posture control device 1102 that controls the posture of the vehicle body 1101.

The vehicle body posture control device 1102 detects the posture of the vehicle body 1101 based on the detection signal, and controls hardness/softness of a suspension or controls brakes of individual wheels 1103 according to a detection result.

In addition, the detection signal of the inertial measurement unit 200 may be used in other applications such as a keyless entry, an immobilizer, a car navigation system, a car air conditioner, an anti-lock brake system (ABS), an airbag, a tire pressure monitoring system (TPMS), an engine control, a control device of inertial navigation for autonomous driving, and an electronic control unit (ECU) such as a battery monitor for a hybrid automobile or an electric automobile.

In addition, the inertial measurement unit 200 may be mounted on other moving objects other than the automobile 1100. For example, the inertial measurement unit 200 is mounted on a moving object such as a bipedal robot, a train, a radio-controlled airplane, a radio-controlled helicopter, a drone, an agricultural machine, and a construction machine. As a result, the moving object can use the detection signal of the inertial measurement unit 200 for posture control, position measurement, and the like of the moving object.

As described above, in the present embodiment, the moving object such as the automobile 1100 is equipped with the inertial measurement unit 200 including the inertial sensor module 100. The inertial sensor module 100 can maintain or ensure the reliability of the detection accuracy even when an external fluctuation such as application of a bending stress or a temperature change is applied.

Therefore, according to the present embodiment, it is possible to improve the reliability of the moving object including the inertial sensor module 100.

### 4.2. Overview of Portable Device

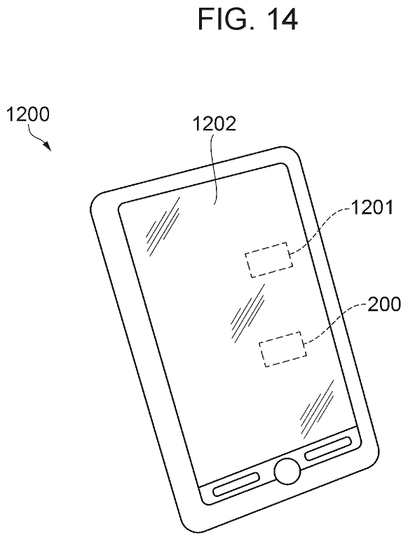

FIG. 14 is a perspective view of a portable device as the electronic apparatus according to Embodiment 4, and is a view illustrating a configuration of a smartphone 1200 as an example of the portable device.

The smartphone 1200 is equipped with the inertial measurement unit 200 including the inertial sensor module 100.

The detection signal detected by the inertial measurement unit 200 is output to a control circuit 1201, and the control circuit 1201 can recognize a posture or behavior of the smartphone 1200 from the received detection signal, and can change a display image displayed on a display section 1202, sound a warning sound or an effect sound, or drive a vibration motor to vibrate a main body.

In addition, the inertial measurement unit 200 may be mounted on other portable devices other than the smartphone 1200. For example, the inertial measurement unit 200 may be mounted on a portable device such as a smartwatch, a portable activity meter, a head mounted display (HMD), a mobile personal computer (PC), a tablet PC, a camera, and a personal digital assistant (PDA). As a result, the portable device can recognize the posture and behavior of the portable device by the detection signal from the inertial measurement unit 200, and can change the display image, sound a warning sound or an effect sound, drive the vibration motor to vibrate the main body, or the like.

As described above, in the present embodiment, a portable device such as the smartphone 1200 is equipped with the inertial measurement unit 200 including the inertial sensor module 100. The inertial sensor module 100 can maintain or ensure the reliability of the detection accuracy even when an external fluctuation such as application of a bending stress or a temperature change is applied.

Therefore, according to the present embodiment, it is possible to improve the reliability of the portable device including the inertial sensor module 100.

As described above, the automobile 1100 and the smartphone 1200 as the electronic apparatus of the present embodiment include the inertial sensor module 100 described above.

Therefore, it is possible to improve the reliability of the automobile 1100 and the smartphone 1200.

The preferred embodiments have been described above, but the present disclosure is not limited to the above-described embodiments. In addition, the configuration of each portion of the present disclosure can be replaced with any configuration that exhibits the same functions as those of the above-described embodiments, and any configuration can be added.

What is claimed is:

1. An inertial sensor module comprising:
a first inertial sensor that detects a physical quantity of a first axis;
a second inertial sensor that detects the physical quantity of the first axis; and
a substrate including a first region in which the first inertial sensor and the second inertial sensor are mounted, a second region surrounding the first region, and a plurality of slits provided between the first region and the second region to surround the first region.

2. The inertial sensor module according to claim 1, wherein
the substrate includes an external coupling portion provided in the second region.

3. The inertial sensor module according to claim 1, wherein
the substrate includes a processing device provided in the second region and processing a first detection signal of the first inertial sensor and a second detection signal of the second inertial sensor.

4. The inertial sensor module according to claim 1, wherein
the plurality of slits are provided to surround four sides of the first inertial sensor and the second inertial sensor.

5. The inertial sensor module according to claim 1, wherein
the substrate includes a plurality of support portions provided between the plurality of slits, and
the plurality of support portions are provided to surround three or four sides of the first inertial sensor and the second inertial sensor.

6. The inertial sensor module according to claim 5, wherein
the plurality of slits include a first slit, a second slit, a third slit, and a fourth slit, and
the plurality of support portions include a first support portion provided between the first slit and the second slit, a second support portion provided between the second slit and the third slit, a third support portion provided between the third slit and the fourth slit, and a fourth support portion provided between the fourth slit and the first slit.

7. The inertial sensor module according to claim 5, wherein
the plurality of slits include a first slit, a second slit, and a third slit, and
the plurality of support portions include a first support portion provided between the first slit and the second slit, a second support portion provided between the second slit and the third slit, and a third support portion provided between the third slit and the first slit.

8. An inertial sensor module comprising:
a first inertial sensor that detects a physical quantity of a first axis;
a second inertial sensor that detects the physical quantity of the first axis; and
a substrate including a first region in which the first inertial sensor and the second inertial sensor are mounted, a second region surrounding the first region, a third region surrounding the first region between the first region and the second region, a first plurality of slits provided between the first region and the third region to surround the first region, and a second plurality of slits provided between the third region and the second region to surround the third region.

9. The inertial sensor module according to claim 8, wherein
the substrate includes an external coupling portion provided in the second region.

10. The inertial sensor module according to claim 8, wherein
the substrate includes a processing device provided in the second region and processing a first detection signal of the first inertial sensor and a second detection signal of the second inertial sensor.

11. The inertial sensor module according to claim 8, wherein
the first plurality of slits and the second plurality of slits are provided to surround four sides of the first inertial sensor and the second inertial sensor.

12. The inertial sensor module according to claim 8, wherein
the substrate includes a first plurality of support portions provided between the first plurality of slits, and
the first plurality of support portions overlap any of the second plurality of slits when viewed from a center of the first region.

13. The inertial sensor module according to claim 12, wherein
the substrate includes a second plurality of support portions provided between the second plurality of slits, and
the first plurality of support portions do not overlap any of the second plurality of support portions when viewed from the center of the first region.

14. The inertial sensor module according to claim 8, wherein
the substrate includes a first plurality of support portions provided between the first plurality of slits and a second plurality of support portions provided between the second plurality of slits, and
the first plurality of support portions and the second plurality of support portions are provided to surround three or four sides of the first inertial sensor and the second inertial sensor.

15. The inertial sensor module according to claim 14, wherein
the first plurality of slits include a first slit, a second slit, a third slit, and a fourth slit,
the first plurality of support portions include a first support portion provided between the first slit and the second slit, a second support portion provided between the second slit and the third slit, a third support portion provided between the third slit and the fourth slit, and a fourth support portion provided between the fourth slit and the first slit,
the second plurality of slits include a fifth slit, a sixth slit, a seventh slit, and an eighth slit, and
the second plurality of support portions include a fifth support portion provided between the fifth slit and the sixth slit, a sixth support portion provided between the sixth slit and the seventh slit, a seventh support portion provided between the seventh slit and the eighth slit, and an eighth support portion provided between the eighth slit and the fifth slit.

16. The inertial sensor module according to claim 14, wherein
the first plurality of slits include a first slit, a second slit, and a third slit,
the first plurality of support portions include a first support portion provided between the first slit and the second slit, a second support portion provided between the second slit and the third slit, and a third support portion provided between the third slit and the first slit,
the second plurality of slits include a fourth slit, a fifth slit, and a sixth slit, and
the second plurality of support portions include a fourth support portion provided between the fourth slit and the fifth slit, a fifth support portion provided between the fifth slit and the sixth slit, and a sixth support portion provided between the sixth slit and the fourth slit.

17. The inertial sensor module according to claim 1, wherein
the first inertial sensor and the second inertial sensor are different in type and the number of detection axes.

18. The inertial sensor module according to claim 1, wherein
the first inertial sensor and the second inertial sensor are the same in type and the number of detection axes.

19. An inertial measurement unit comprising the inertial sensor module according to claim 1.

20. An electronic apparatus comprising the inertial sensor module according to claim 1.
